(19) United States
(12) Patent Application Publication
(10) Pub. No.: US 2013/0242377 A1
(43) Pub. Date: Sep. 19, 2013

(54) Transparent Planar Element Having a Variable Transmittance

(71) Applicants: Juergen Setzer, Muehlacker (DE); Stefan Muehlberger, Gaertringen (DE); Juergen Luka, Tamm (DE)

(72) Inventors: Juergen Setzer, Muehlacker (DE); Stefan Muehlberger, Gaertringen (DE); Juergen Luka, Tamm (DE)

(73) Assignee: Daimler AG, Stuttgart (DE)

(21) Appl. No.: 13/822,729

(22) PCT Filed: Oct. 13, 2011
(86) PCT No.: PCT/EP2011/005152

§ 371 Date: Apr. 16, 2013

(30) Foreign Application Priority Data
Dec. 9, 2010 (DE) 10 2010 053956.2

(51) Int. Cl. G02F 1/01; G02F 1/167

(52) U.S. Cl. CPC G02F 1/0121; G02F 1/167
USPC 359/296

(57) ABSTRACT

A transparent panel element formed as a glass surface includes an array, the variable total transmission factor of which can be controlled through application of an operating voltage. The array includes several films, which are inserted into and/or applied to the panel element in layers, and the transmission factors of which can be independently controlled

### BACKGROUND AND SUMMARY OF THE INVENTION

Exemplary embodiments of the present invention relate to a transparent panel or planar element, in particular one formed as a glass surface, comprising an array, the variable total transmission factor of which can be controlled through application of an operating voltage. Exemplary embodiments of the present invention also relate to a device and a method for the operation of at least one transparent panel element, as well as a vehicle with at least one transparent panel element.

German Patent Document DE 10 2008 060 040 A1 discloses a device for the operation of transparent panel elements, in particular glass surfaces, with a variable transmission factor. The device comprises a source of electrical energy with a source voltage, a transmission line and means for converting the source voltage into an operating voltage for the transparent panel elements. These means encompass a converter with an integrated controller by means of which the source voltage may be converted into an AC voltage lower than the operating voltage, and, attached directly to each transparent panel element, one transformer allocated to each such panel element by means of which the operating voltage may be generated from the AC voltage.

U.S. Pat. No. 6,804,040 B2 discloses a device for controlling an electrical voltage for supplying a suspended particle device (SPD). The device comprises an electrical connection for receiving an AC voltage signal, a dividing unit to split the AC voltage signal into several independent voltage signals within a specified range, a controller to control the dividing unit, in order to provide a selected voltage value based on voltage level information, and an electrical connection to provide the selected voltage value to the suspended particle device. The voltage level information may be set by means of an input unit or by a photocell that registers light intensity at the suspended particle device.

The applicant's unpublished German patent application with the official file number 102010033556.8 (German Published Patent Document DE 10 2010 056203 claims priority to this unpublished application) describes a device for the operation of transparent panel elements, in particular glass surfaces, with a variable transmission factor. The device comprises a source of electrical energy, a transmission line, and a converter to convert the source voltage to a first AC voltage. The converter for converting the source voltage to a first AC voltage comprises at least one analog oscillator circuit. The device further comprises transformers, one attached directly to each transparent panel element, to convert the first AC voltage. The transparent panel elements each feature means, the transmission factor of which can be controlled through the application of an operating voltage, namely an electrical DC voltage with a fundamental frequency. These means consist of a film emplaced in or applied to each panel element. These films are suspended particle devices, which contain light-absorbing particles that attain maximum transparency when the operating voltage is applied and minimum transparency when no voltage is applied. Also described is a method for the operation of transparent panel elements.

Exemplary embodiments of the present invention provide an improved transparent panel element, an improved device for the operation of transparent panel elements, and an improved method for the operation of transparent panel elements. Exemplary embodiments of the present invention also provide a novel vehicle having at least one transparent panel element.

A transparent panel element, in particular one formed as a glass surface, comprises an array, the variable total transmission factor of which can be controlled through application of an operating voltage. In accordance with the invention, the array comprises several films which are inserted into and/or applied to the panel element in layers, and the transmission factors of which can be controlled independently.

These films are suspended particle devices (SPDs), which contain light-absorbing particles, the maximum transparency of which is attained when subject to the operating voltage, and the minimum transparency of which is attained when no voltage is being applied to them. The switching behaviour of the SPD films depends on the thickness of the film; as the thickness of a film increases, the time required for switching from the inactive state with minimal transparency to an active state with maximum transparency also increases. The switching behaviour also depends on the ambient temperature, with switching time increasing as ambient temperature declines. Due to the construction of the array from multiple films, the thickness of each such film is lower than that of a single film. This improves the switching behaviour of the array, as the activation times of the layered, thinner films are reduced as compared with that of a thicker film. Consequently, even at low ambient temperatures, it is possible to switch rapidly between the inactive and the active state of the SPD film, and the desired level of transparency may be rapidly achieved.

In the case that such a transparent panel element is used in a vehicle, this results in increased comfort for the vehicle's occupants, an optimal and desired view at all times, and visibility, and consequently improved safety.

At the same time, due to the multi-layered arrangement of the films, it is possible in a particularly advantageous manner to adjust the total transmission factor of the panel element in small, defined intermediate stages by regulating the transmission factors of the individual films.

In order to prevent mutual interference between the films, the individual films are electrically insulated from one another in accordance with an advantageous further embodiment.

In one embodiment of the transparent panel element, at least one of the films is formed in such a way that, through application and/or variation of the operating voltage, symbols and/or graphical characters can be depicted, and/or symbol-shaped or character-shaped means are emplaced between at least two layers of the films such that symbols and/or characters can be depicted by regulating the transmission factor of the films. Consequently, it is easily possible in an advantageous manner to depict logos, writing, advertisements, and/or other design elements by means of the transparent panel element.

The device for the operation of at least one transparent panel element includes at least one transformer to convert the first AC voltage into a second AC voltage as the operating voltage of the array, with the transformer having multiple electrical output connections, each output connection being electrically connected to one film, and with a separate operating voltage capable of being generated from the first AC voltage for each film. The transmission factors of the films may thus be separately regulated with little difficulty, and a defined total transmission factor may easily be set for the transparent panel element. Also, due to the use of the transformer with multiple electrical output connections, only one transformer is required for the operation of all films of the one transparent panel element.

In particular, the device further comprises at least one source of electrical energy, at least one transmission line, and at least one converter for transforming a source voltage from the energy source into the first AC voltage.

In accordance with one advantageous embodiment, the first AC voltage can be generated at a lower voltage level from the source voltage by means of the at least one converter. Due to the transmission of the electrical energy from the energy source to the at least one transformer in the form of such an AC voltage, no complex high voltage transmission line is needed; accordingly, the transmission line used is distinguished not only by its excellent flexibility, but by very low weight and low cost in consequence of the reduced scale of insulation required. In addition, few or no measures for the electrical screening and insulation of the at least one transmission line against higher electrical voltages and/or electrical systems as well as contacts that are capable of forming contacts or which are conductive are required, in particular within in a vehicle, as the chosen AC voltage at a low voltage level results in good electromagnetic compatibility. A simplification of safety measures to prevent accidental contacting, i.e. to protect against electric shock, may also be profitably achieved.

Furthermore, a higher second AC voltage may be generated as an operating voltage from the first AC voltage by means of the transformer. In an advantageous further embodiment of the device, the transformer is affixed to the transparent panel element by means of a bonded, force-locking, and/or positive connection. In this way, especially short transmission paths of the second AC voltage generated may be achieved, and consequently low electrical losses.

The method for the operation of at least one transparent panel element involves individually regulating the transmission factors of each individual film of the array in order to set a defined total transmission factor for the panel element. Through the use of the method in accordance with the invention, it is possible to easily adjust the defined total transmission factor, either in finely graduated stages or varying continuously.

The vehicle in accordance with the invention has at least one transparent panel element, such panel element comprising a vehicle window and/or a vehicle sunroof. In consequence of the composition of the panel element, the transmission factors of the vehicle windows and/or the sunroof of the vehicle can be adjusted with very fast switching times, in particular even at low temperatures. Due to this composition of the panel element, very fast switching times between various total transmission factors of the panel element are possible, and the total transmission factor of the panel elements may simultaneously be adjusted, in small, defined stages or continuously, through regulating the transmission factors of the individual films. This contributes to the increased safety and comfort of the occupants of the vehicle.

In a further embodiment of the vehicle, this also encompasses the device to control the operation of the at least one transparent panel element, such that the transmission factors of the films may be individually and easily controlled and that the defined total transmission factor of the transparent panel element may be adjusted in a simple manner.

### BRIEF DESCRIPTION OF THE DRAWING FIGURES

Exemplary embodiments of the invention are described in detail below by means of drawings.

Shown are the following:

FIG. 1 a schematic representation of a vehicle with multiple transparent panel elements with adjustable total transmission factors and

FIG. 2 a schematic representation of a transparent panel element in accordance with FIG. 1.

The same reference numbers are used for equivalent components in all figures.

### DETAILED DECRIPTION

It should be noted that the preferred application of the exemplary embodiments of the present invention is in a vehicle, e.g. a motor vehicle, the windows, roof panels, etc. of such vehicle being of variable transparency.

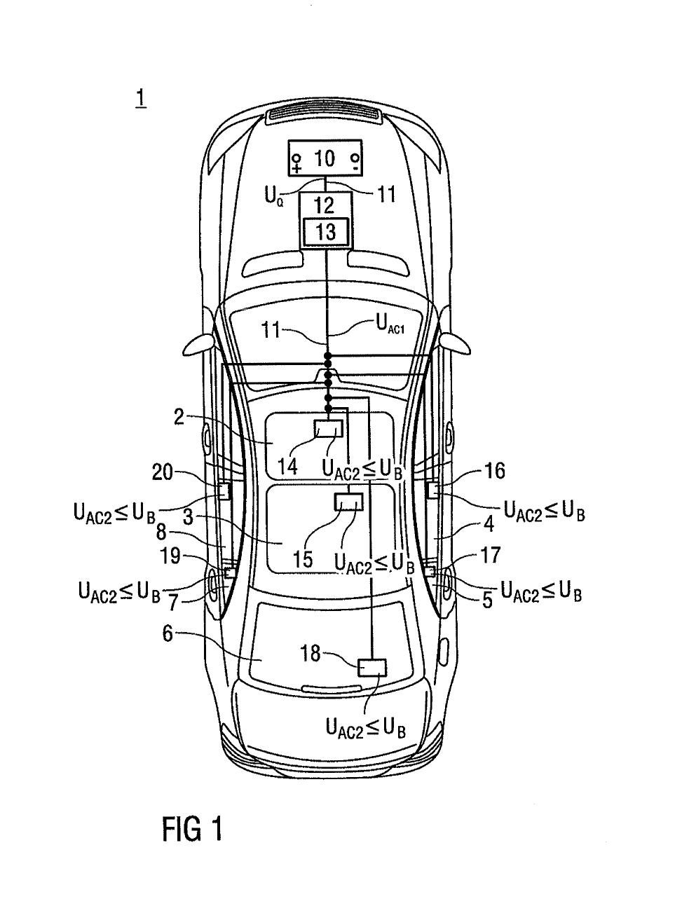

FIG. 1 depicts a vehicle 1 with several transparent panel elements 2 through 8 having a variable transmission factor.

The transparent panel elements 2 through 8 are glass surfaces, specifically a first moveable glass sunroof (panel element 2), a second fixed glass roof (panel element 3), a right and a left moveable side window (panel element 4 and panel element 8), a right and a left fixed side window (panel element 5 and panel element 7), and a rear window (panel element 6) of the vehicle 1.

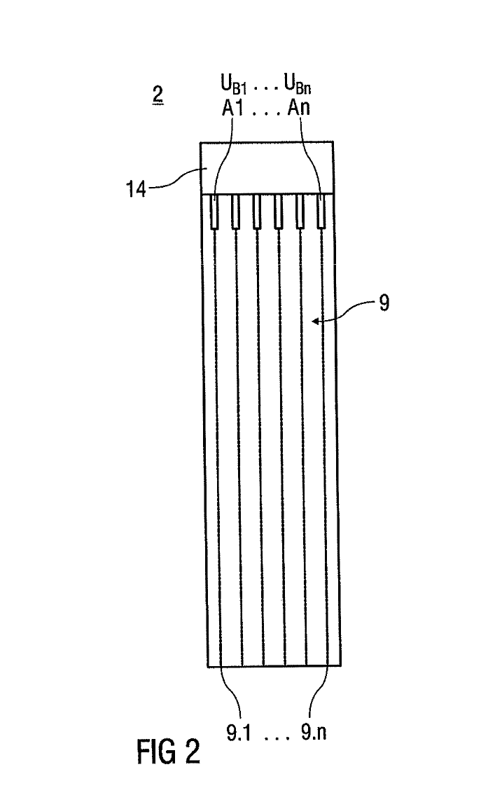

The transparent panel elements 2 through 8 each have an array 9, depicted in greater detail in FIG. 2, comprising several films 9.1 through 9.n arranged in layers, and the total transmission factor of which may be adjusted. The films 9.1 through 9.n are emplaced within the panel elements 2 through 8 in accordance with FIG. 2. The films 9.1 through 9.n are alternatively or additionally applied to the corresponding panel elements 2 through 8.

The films 9.1 through 9.n are formed in such a way that the transmission factor of each may be adjusted through application of an operating voltage U_{B}, in particular of individually adjustable operating voltages U_{B1} through U_{Bn}, which are AC voltages having a fundamental frequency. The films 9.1 through 9.n are suspended particle devices (SPDs) which contain light-absorbing particles, the maximum transparency of which is attained when subject to the operating voltage U_{B} or the operating voltages U_{B1} through U_{Bn}, and the minimum transparency of which is attained when no voltage is being applied to them.

In the exemplary embodiment of the invention depicted, a battery is provided as an energy source 10 for the operation of the transparent panel elements 2 through 8, such battery having a DC voltage as source voltage U_{Q}. Such DC voltage may be, e.g., 12 volts.

As a low-range AC voltage is particularly suitable for the transmission of electrical energy from the energy source 10 to the transparent panel elements 2 through 8 due to its very good electromagnetic compatibility and the ability to omit high-voltage safety precautions on a transmission line 11, a converter 12 is located immediately after the energy source 10.

In exemplary embodiments not described in further detail, multiple transmission lines 11 and multiple converters 12 are provided. It is possible that one transmission line 11 and/or one converter 12 is provided for each one transparent panel element 2 through 8.

By means of the converter 12, the source voltage U_{Q} may be converted into an adjustable-frequency or fixed first AC voltage U_{AC1}, with the first AC voltage U_{AC1} preferably having a maximum voltage level lower than the source voltage U_{Q}.

The first AC voltage U_{AC1} is determined specifically as follows:

$${U}_{AC 1} \leq \frac{{U}_{Q}}{2 * \sqrt{2}} . \qquad [ 1 ]$$

The first AC voltage U_{AC1} preferably has a voltage level in the region of 2 V to 3 V.

To convert the source voltage U_{Q} into the first AC voltage U_{AC1}, the converter 12 has an analog oscillator circuit 13. This oscillator circuit 13 has, in a manner not further described, an analog oscillator in the form of a sine wave oscillator, by means of which the first AC voltage U_{AC1} is generated from the source voltage U_{Q}.

The oscillator circuit 13 further comprises an analog amplifier circuit (not shown) with multiple analog amplifiers, each allocated to one of the panel elements 2 through 8, by means of which the voltage level of the first AC voltage U_{AC1} may be individually determined for each of the transparent panel elements 2 through 8. The first AC voltage U_{AC1} is set in such a manner that these values are in a range between zero and the maximum operating voltage U_{B}.

These analog amplifiers are specifically analog output stages, which are operated in what is known as AB mode. Such output stages offer the advantage of a low standby current in the mA range, and “crossover” and “deadband” distortions are avoided.

In an exemplary embodiment not further depicted, the converter 12 comprises, in addition or alternatively to the analog oscillator circuit 13, a digital circuit for converting the source voltage U_{Q} into the first AC voltage U_{AC1}. To this end, the digital circuit comprises one or more microcontrollers and/or one or more digital to analog converters. By means of the at least one digital to analog converter, e.g. an 8-bit and/or 16-bit digital-analog conversion may be effected in order to generate the first AC voltage U_{AC1}, which is specifically a sinusoidal AC voltage.

It is also possible for the converter 12 to comprise multiple analog and/or digital oscillators in the manner described. The number of oscillators may correspond to the number transparent panel elements 2 through 8, or may be larger or smaller, such that a flexible configuration and/or allocation of the oscillator circuits to the transparent panel elements 2 through 8 is possible.

In the illustrated exemplary embodiment of the invention the AC voltage U_{AC1} is set at such a level that no elaborate measures to create electromagnetic compatibility or protect against accidental contacting are necessary.

As a second AC voltage U_{AC2} higher than the transmitted first AC voltage U_{AC1} is necessary to operate the films 9.1 through 9.n located in or on the transparent panel elements 2 through 8, such as 120 V or 140 V, a transformer 14 through 20 each allocated to one panel element 2 through 8 is situated directly on each panel element 2 through 8, by means of which the second AC voltage U_{AC2} may be generated from the first AC voltage U_{AC1} as the operating voltage U_{B} at a higher voltage level.

FIG. 2 depicts the transparent panel element 2 with the transformer 14 situated on it.

The transparent panel element 2 has the array 9 comprised of the several films 9.1 through 9.n arranged in layers; in the exemplary embodiment depicted, the films 9.1 through 9.n are emplaced in the panel element 2. The films 9.1 through 9.n are emplaced in the panel element 2 in such a way that they are electrically insulated from one another. In the alternative or in addition, the films 9.1 through 9.n are applied to the transparent panel element 2, with these films also being electrically insulated from one another.

The transformer 14 to generate the second AC voltage U_{AC2} as the operating voltage U_{B} or the operating voltages U_{B1} through U_{Bn} is located on the transparent panel element 2. In order to avoid compromising the visual appearance of the vehicle 1 or of vehicular components, the transformer 14 is affixed directly to the transparent panel element 2 through bonding, force-locking, and/or positive attachment methods.

These bonding, force-locking, and/or positive attachments may be created e.g. by means of direct adhesion, vulcanization, casting, and/or molding of the transformer 14 to the transparent panel element 2.

The transformer 14 has multiple electrical output connections A1 through An, with each electrical output connection A1 through An being electrically connected with one film 9.1 through 9.n.

In a manner not further described, the transparent panel element 2 has electrical connection elements not further described corresponding with the transformer 14, and in particular with its electrical output connections A1 through An, which in a particularly advantageous manner also comprise means of attachment for affixing the transformer 14 to the transparent panel element 2.

To adjust and control the total transmission factor of the array 9, the individual transmission factors of the films 9.1 through 9.n are set by the application of electrical energy via the electrical output connections A1 through An. A separate operating voltage U_{B1} through U_{Bn} may be generated for each of the films 9.1 through 9.n.

By separately switching on or off the individual films 9.1 through 9.n, a defined setting of the total transmission, in particular a defined gradation of the total transmission of the array 9, and thus of the transparent panel element 2, is controllable. The total transmission factor of the array 9 or the transparent panel element 2 is the sum of the individual transmission factors of the films 9.1 to 9.n. The films 9.1 through 9.n may have various dimensions, thicknesses, shapes, and differing optical characteristics, and in particular individual transmission factors, such that an individualized and optimized adjustment of the total transmission factor is possible. The individual transmission factors are also preferably adjustable in stages or continuously, so that a large number of different total transmission factors may be generated.

A static and dynamic synchronicity of the adjustment of the total transmission of the panel elements 2 through 8, which are distinguished by varying surfaces and shapes and consequently by differing electrical parameters, is not affected, as the total transmission factor is controlled by the separate adjustment of the transmission factors of the individual films 9.1 through 9.n. The differing electrical parameters resulting from the varying areas and shapes of the panel elements 2 through 8 are a parallel equivalent resistance (Rp), a series equivalent resistance (Rs), and a series equivalent capacitance (Cs). The adjustment of the total transmission factor through controlling the individual transmission factors of the films 9.1 through 9.n particularly sets itself apart from adjustment of the total transmission factor via simple amplitude variation through its ease of realization.

The transformer 14 for example has a fixed transformation ratio, so that the controlling of the total transmission factor, i.e. the second AC voltage U_{AC2}, is effected by adjusting the voltage level and/or a frequency of the first AC voltage U_{AC1} by means of the converter 12. Thus, all transparent panel elements 2 through 8 exhibit the same transmission factor.

The remaining panel elements 3 through 8 correspond in their design and function with respect to controlling the total transmission factor to the panel element 2, and each have the array 9 with the films 9.1 through 9.n. The remaining transformers 15 through 20 also correspond in their design and function to the transformer 14.

To control the adjustment of the voltage level and/or the frequency of the first AC voltage U_{AC1}, a central unit (not shown) is integrated into the converter 12 by means of which the conversion of the source voltage U_{Q} into the first AC voltage U_{AC1} for all transparent panel elements 2 through 8 may be controlled.

In the alternative, it is also possible in a manner not further depicted to allocate to several or each of the panel elements 2 through 8 one converter 12 each with an integrated central unit and with a transformer 14 through 20, such that the transmission factor can be separately adjusted for multiple groups of panel elements 2 through 8 or for each panel element 2 through 8.

In order to adjust the total transmission factor of the transparent panel elements 2 through 8 in stages or continuously, an operating panel not further described is situated inside the passenger cell of the vehicle, with the converter 12 and/or the central unit being controllable by means of the operating panel such that the total transmission factor of the transparent panel elements 2 through 8 may be controlled and adjusted. For this purpose, the operating panel is connected to the central unit, either directly or by means of a data bus, for example a CAN bus or LIN bus.

The converter 12 and the central unit are preferably situated in a metal housing, and have a short ground connection to the body of the vehicle 1 for the purpose of improving electromagnetic compatibility.

The converter 12 additionally has a diagnostic device (not shown), with such diagnostic device being connected to the analog amplifiers.

The source voltage U_{Q} is monitored by means of the diagnostic device. To this end, the diagnostic device comprises one or more sensor devices.

An AC voltage secondary circuit (not shown) situated between the converter 12 and the panel elements 2 through 8 is also monitored by means of the diagnostic device for interruptions and short circuits. In addition, the first AC voltage U_{AC1}, the second AC voltage U_{AC2}, and the operating voltage U_{B} are monitored. To this end, the diagnostic device comprises one or more sensor devices, in particular ammeters and/or voltmeters.

To control the analog amplifiers and the diagnostic device, these are both connected to the central unit, so that it is possible by means of the central unit to control the converter 12 and diagnose the converter 12, the DC voltage primary circuit, the AC voltage secondary circuit, and the panel elements 2 through 8.

Additionally, the central unit communicates via the data bus with one or more vehicle control devices (not shown), and in particular with the operating panel to adjust the total transmission factor.

In a further embodiment of the array (not shown), the films 9.1 through 9.n are formed in such a way that, when the operating voltage U_{B} is applied and/or varied, symbols and/or characters are depicted.

To this end, the films 9.1 through 9.n have varying shapes and dimensions, and are emplaced in various positions within or applied to the transparent panel elements 2 through 8, so that, through the separate adjustment of the transmission factors of selected films 9.1 through 9.n, the symbols and/or characters are depicted. Alternatively or additionally, the films 9.1 through 9.n are each divided into multiple regions. These regions are formed in particular in a grid form and can be separately controlled, such that, by discrete activation or deactivation of the regions of one or more of the films 9.1 through 9.n, the symbols and/or characters are generated or composed.

Alternatively to the direct generation of the symbols and/or characters by means of the films 9.1 through 9.n, symbol-shaped and/or character-shaped means are emplaced between at least two layers of the films 9.1 through 9.n (also in a manner not shown) such that these are made visible by the activation and/or deactivation of one or more films 9.1 through 9.n, and thus the symbols and/or characters may be depicted.

In a further, not depicted embodiment of the array, one or more heating layers, such as e.g. conducting or semiconducting transparent ITO (iridium tin oxide) layers, are provided between each or any two of the films 9.1 through 9.n, which are connected to a suitable energy source. Upon application of an appropriate energy to the one or more heating layers, the films 9.1 through 9.n are heated. This leads to faster response times in switching the transparency of the films 9.1 through 9.n, particularly in conditions of low temperatures.

The heating layers may be provided between all contiguous films 9.1 through 9.n, or only between one or more of the films 9.1 through 9.n. Furthermore, the heating layers are electrically insulated from the films 9.1 through 9.n.

Though the present invention has been described as set forth above by means of an exemplary embodiment, it is understood that various embodiments and modifications could be realized without exceeding the scope of the present invention as defined in the attached list of claims.

With regard to further features and advantages of the present invention, reference is explicitly made to the disclosure of the drawing.

1-10. (canceled)

11. A transparent panel element formed as a glass surface, comprising:
an array, a variable total transmission factor of which can be controlled through application of an operating voltage,
wherein the array comprises several films, which are emplaced in or applied to the panel element in layers, and the several films are configured so that transmission factors of each of the several films are independently controllable.

12. The transparent panel element in accordance with claim 11, wherein the individual films are electrically insulated from one another.

13. The transparent panel element in accordance with claim 11, wherein at least one of the films is configured in such a manner that symbols or characters are displayed when an operating voltage or a varying operating voltage is applied to the at least one of the films, or symbol-shaped or character-shaped means are emplaced between at least two layers of the several films in such a manner that symbols or characters are displayed by regulating the transmission factors of the films.

14. A device for the operation of at least one transparent panel element formed as a glass surface and which comprises an array, a variable total transmission factor of which can be controlled through application of an operating voltage, wherein the array comprises several films, which are emplaced in or applied to the panel element in layers, and the several films are configured so that transmission factors of each of the several films are independently controllable, the device comprising:
at least one transformer configured to transform a first AC voltage into at least one second AC voltage as the operating voltage of the array, wherein the transformer has multiple electric output connections, each of the multiple output connections is electrically connected to one of the several films, and wherein the at least one transformer is configured to generate a separate operating voltage for each of the several films from the first AC voltage.

15. The device in accordance with claim 14, further comprising:
at least one source of electrical energy;
at least one transmission line; and
at least one converter configured to convert a source voltage of the energy source into the first AC voltage.

16. The device in accordance with claim 15, further comprising:
a converter configured to generate the first AC voltage with a reduced voltage level from the source voltage, wherein the at least one transformer is configured to generate the second AC voltage as an operating voltage with an increased voltage level from the first AC voltage.

17. The device in accordance with claim 14, wherein the transformer is situated directly on the transparent panel element.

18. A method for the operation of at least one transparent panel element formed as a glass surface and which comprises an array, a variable total transmission factor of which can be controlled through application of an operating voltage, wherein the array comprises several films, which are emplaced in or applied to the panel element in layers, and the several films are configured so that transmission factors of each of the several films are independently controllable, the method comprising:
setting a defined total transmission factor of the at least one transparent panel element by individually adjusting the transmission factors of the films of the array.

19. A vehicle, comprising:
at least one transparent panel element formed as a glass surface and which comprises an array, a variable total transmission factor of which can be controlled through application of an operating voltage, wherein the array comprises several films, which are emplaced in or applied to the panel element in layers, and the several films are configured so that transmission factors of each of the several films are independently controllable; and
a device comprising at least one transformer configured to transform a first AC voltage into at least one second AC voltage as the operating voltage of the array, wherein the transformer has multiple electric output connections, each of the multiple output connections is electrically connected to one of the several films, and wherein the at least one transformer is configured to generate a separate operating voltage for each of the several films from the first AC voltage,
wherein the at least one transparent panel element is a vehicle window or vehicle sunroof.
